(19) United States
(12) Patent Application Publication
(10) Pub. No.: US 2003/0169334 A1
(43) Pub. Date: Sep. 11, 2003

(54) Iris capture device having expanded capture volume

(76) Inventors: Michael Braithwaite, Langhorne, PA (US); Kevin C. Kaighn, Mt. Laurel, NJ (US); Randal W. Glass, Cherry Hill, NJ (US)

Correspondence Address: Woodcock Washburn Kurtz, Mackiewicz & Norris LLP, 46th Floor, One Liberty, Philadelphia, PA, 19103, US

(21) Appl. No.: 09/922,981

(22) Filed: Aug. 6, 2001

(51) Int. Cl. H04N 7/18

(52) U.S. Cl. 348/78; 348/61

(57) ABSTRACT

An improved system and method for personal identity biometric authentication using an iris acquisition device having an expanded capture volume to enable greater ease of use, overcomes the problem of eyeglass reflections to avoid false rejections, has no moving parts thereby enhancing reliability, and achieves low cost through use of a simple design and commonly available components. The invention is directed to an apparatus, system, and method for expanding the capture volume by extending the iris image capture zone in one or more axes (X, Y, and/or Z). The iris image capture device includes a cooperating pair of lens systems and illuminators wherein each individual lens system/illuminator system has a known separation and is capable of capturing an image of either or both a right eye and a left eye of a user thereby extending am apparent width of filed in an X-axis. The lens systems of the iris image capture device can also be physically and/or optically offset from one another resulting in an extended apparent depth of field in a Z-axis. In addition, each individual lens system/illuminator system preferably has a minimum angular separation that ensures that no reflections due to eyeglasses fall onto the iris image area.

### FIELD OF THE INVENTION

The present invention relates in general to personal identification biometric authentication systems, and particularly, to an iris authentication system having an expanded capture volume.

### BACKGROUND OF THE INVENTION

The need to establish personal identity occurs, for most individuals, many times a day. For example, a person may have to establish identity in order to gain access to, physical spaces, computers, bank accounts, personal records, restricted areas, reservations, and the like. Identity is typically established by something we have (e.g., a key, driver license, bank card, credit card, etc.), something we know (e.g., computer password, PIN number, etc.), or some unique and measurable biological feature (e.g., our face recognized by a bank teller or security guard, etc.). The most secure means of identity is a biological (or behavioral) feature that can be objectively and automatically measured and is resistant to impersonation, theft, or other fraud.

The use of biometrics, which are measurements derived from human biological features, to identify individuals is a rapidly emerging science. Biometrics include fingerprints, facial features, hand geometry, voice features, and iris features, to name a few. In the existing art, biometric authentication is performed using one of two methodologies.

In the first, verification, individuals wishing to be authenticated are enrolled in the biometric system. This means that a sample biometric measurement is provided by the individual, along with personal identifying information, such as, for example, their name, address, telephone number, an identification number (e.g., a social security number), a bank account number, a credit card number, a reservation number, or some other information unique to that individual. The sample biometric is stored along with the personal identification data in a database. When the individual seeks to be authenticated, he or she submits a second biometric sample, along with some personal identifying information, such as described above, that is unique to that person. The personal identifying information is used to retrieve the person's initial sample biometric from the database. This first sample is compared to the second sample, and if the samples are judged to match by some criteria specific to the biometric technology, then the individual is authenticated. As a result of the authentication, the individual may be granted authorization to exercise some predefined privilege(s), such as, for example, access to a building or restricted area, access to a bank account or credit account, the right to perform a transaction of some sort, access to an airplane, car, or room reservation, and the like.

The second form of biometric authentication is identification. Like the verification case, the individual must be enrolled in a biometric database where each record includes a first biometric sample and accompanying personal identifying information which are intended to be released when authentication is successful. In order to be authenticated the individual submits only a second biometric sample, but no identifying information. The second biometric sample is compared against all first biometric samples in the database and a single matching first sample is found by applying a match criteria. The advantage of this second form of authentication is that the individual need not remember or carry the unique identifying information required in the verification method to retrieve a single first biometric sample from the database.

However, it should be noted that successful use of either authentication methodology requires extremely accurate biometric technology, particularly when the database is large. This is due to the fact that in a database of n first biometric samples, the second sample must be compared to each first sample and there are thus n chances to falsely identify the individual as someone else. When n is very large, the chance of erroneously judging two disparate biometric samples as having come from the same person is preferably vanishingly small in order for the system to function effectively. Among all biometric technologies only iris recognition has been shown to function successfully in a pure identification paradigm, requiring no ancillary information about the individual.

Techniques for accurately identifying individuals using iris recognition are described in U.S. Pat. No. 4,641,349 to Flom et al. and in U.S. Pat. No. 5,291,560 to Daugman. The systems described in these references require clear, well-focused images of the eye.

In order to complete the biometric authentication process using either the verification or the identification methodologies, a clear, well-focused image of an iris portion of at least one eye of an individual is captured using an iris image capture device. However, conventional, non-motorized iris image capture devices typically have a relatively small capture volume that require that the user be positioned in this relatively small iris capture volume (defined by the three coordinates: X, Y, and Z, as shown in FIG. 1) in order for an acceptable iris image to be captured. This leads to difficulties in using the iris image capture device to capture an iris image of sufficient clarity and quality to reliably complete the biometric authentication process.

Several conventional methods are currently used in an attempt to help the user position him or her self with respect to the iris image capture device. For example, these conventional methods include mirrors and indicator lights that the user can visualize in an attempt to properly position him or herself in front of the iris image capture device. However, these conventional methods still require that the user be positioned in a relatively small iris image capture volume, which is difficult to achieve.

Also, although most people are somewhat successful in aligning themselves in the X, Y axes using conventional user interfaces (e.g., mirrors and indicator lights), ensuring proper alignment along the Z-axis (or user distance from the device) is typically harder to achieve. This may be due in part to the fact that peoples' depth perception varies greatly from person to person and also with age. For example, when reading and/or examining something younger people tend to move closer to an item while older people tend to move further away from an item. As a result, ensuring that a person is properly aligned along the Z axis is particularly problematic.

As can be appreciated, these conventional iris capture and biometric authentication system arc difficult to use properly for both initial use and also reoccurring use. Therefore, a need exists for a new, small, low cost iris capture device for biometric authentication of an individual that provides ease of use for the initial use as well as recurring ease of use.

### SUMMARY OF THE INVENTION

The present invention is directed to an apparatus, system, and method for capturing an image of an iris of an eye that achieve an expanded iris image capture volume to enable greater ease of use. The capture volume can be expanded by extending the iris image capture zone in one or more axes (X, Y, and/or Z). The iris image capture device has minimal moving parts thereby enhancing reliability, achieves low cost through use of a simple design and commonly available imaging components. The invention is also directed to an apparatus, system, and method for illuminating and imaging an iris of an eye through eyeglasses using the iris image capture device of the present invention to avoid/reduce false rejections. In addition, an improved user interface can be provided to further improve ease of use of the iris image capture device.

The iris image capture device having an expanded capture volume includes two lens systems and two illuminators. The lens systems include a first lens system and a second lens system that are offset from one another in one or more of a X-axis, a Y-axis, and a Z-axis and arranged to capture an iris image of at least one of a left eye and a right eye. The illuminators include a first illuminator positioned outboard of the second lens system and a second illuminator positioned outboard of the first lens system. The first illuminator and the second illuminator are offset from one another in one or more of a X-axis, a Y-axis, and a Z-axis for illuminating an iris of at least one of a left eye and a right eye. The first lens system operates with the first illuminator and the second lens system operates with the second illuminator to illuminate an iris of an eye and capture an image of the iris.

The component layout of the iris image capture device results in an expanded apparent capture volume defined by dimensions X, Y, and Z, wherein the expanded capture volume is formed by extending a dimension of the capture volume in one or more of an X-axis, a Y-axis, and a Z-axis.

In accordance with one aspect of the present invention, the first lens system and the second lens system are horizontally offset from one another in an X-axis a known distance corresponding to an average eye separation. The first lens system and the first illuminator are horizontally offset from one another in the X-axis and are positioned relative to one another having a known separation and the second lens system and the second illuminator are horizontally offset from one another in the X-axis and are positioned relative to one another having a known separation. Preferably, the known distance corresponding to an average eye separation ensures that the first lens system is on-axis with the left eye and the second lens system is on-axis with the right eye when a user is positioned directly in front of the iris image capture device.

According to another aspect of the present invention, the expanded apparent capture volume of the iris image capture device is formed along an X-axis by extending an apparent width of field along a X-axis by positioning the illuminators outboard of the lens systems and allowing each of the lens systems to capture an iris image of either or both of the left eye and the right eye.

A maximum apparent width of field that extends in the X-axis includes a distance in the X-axis between a maximum right position where a left iris inner boundary is located juxtaposition a right FOV outer boundary wherein an image of a left iris can be captured in the right FOV when a user's head is shifted to the right, and a maximum left position where a right iris inner boundary is located juxtaposition a left FOV outer boundary wherein an image of a right iris can be captured in the left FOV when the user's head is shifted to the left.

According to another aspect of the present invention, the expanded apparent capture volume of the iris image capture device is formed along a Z-axis by extending an apparent depth of field by offsetting the depth of field of each lens system from one another. This can be accomplished by physically offsetting each lens system from one another in the Z-axis and/or optically offsetting each lens system from one another. The optical offset of each lens system can be accomplished by using lens systems having, for example, different lens prescriptions.

According to another aspect of the present invention, a third lens system and a third illuminator can be provided that are vertically offset in a Y-axis from the first and second lens systems, and the first and second illuminators, to form an apparent expanded capture volume along a Y-axis. An expanded apparent capture volume of the iris image capture device is formed along the Y-axis by extending an apparent height of field by offsetting the height of field of each lens system from one another.

According to another aspect of the present invention, the iris image capture device includes a tilt mechanism for rotating the lens systems up and down. According to another aspect of the present invention, the iris image capture device includes a pan mechanism for rotating the lens systems left and right. According to another aspect of the present invention, the iris image capture device includes an autofocus feature for focusing the lens systems on an iris of an eye of a user. According to another aspect of the present invention, the iris image capture device includes a Wide Field Of View (WFOV) camera for locating a position of an eye of a user. An output from the WFOV camera can be used to control one or more of a tilt mechanism and a pan mechanism.

According to another aspect of the present invention, the iris image capture device includes a user interface for assisting a user in positioning him or herself with respect to the iris imaging device in X, Y, Z coordinates. The user interface can include one or more of a visual indicator and an audio indicator. In one preferred embodiment, the user interface includes a partially silvered mirror for selectively viewing one of a reflection of the eyes reflecting off of the partially silvered mirror and a graphic display positioned behind the partially silvered mirror and projected through the partially silvered mirror. The lens systems can be positioned behind the partially silvered mirror to further improve ease of use. Apertures may be provided in the partially silvered mirror along an axis of each of the lens systems for allowing illumination to pass through the partially silvered mirror and enter the lens systems to capture an image of an iris of an eye of the user through the partially silvered mirror.

According to another aspect of the present invention, a minimum angular separation is provided to ensure that no reflections due to eyeglasses fall within an iris image area. The minimum angular separation is defined by an angle formed between a line extending along an illumination axis and a line extending along a lens system axis. The minimum angular separation preferably includes an angle of about 11.3 degrees.

The present invention is also directed to a system for imaging an area of an object positioned behind a light transmissive structure (e.g., eyeglasses) using an illuminator that produce specular reflections on the eyeglasses. The system includes a single lens system having a sensor for capturing an image of the object behind the eyeglasses and a single illuminator for illuminating the object and positioned having a known separation from the lens system. An object distance is defined between the lens system and the object to be imaged. A minimum angular separation is provided and is defined by an angle formed between an illumination axis and a lens system axis, wherein the minimum angular separation ensures that no specular reflections fall onto an area of an object to be imaged. Preferably, the minimum angular separation is an angle of about 11.3 degrees.

The minimum angular separation is ensured by manipulating the separation between the lens system and the illuminator and the object distance between the lens system and the object to be imaged. Preferably, the separation between the lens system and the illuminator varies between about 1.2 inches and about 5.2 inches and the object distance between the lens system and the object to be imaged varies between about 6 inches and about 26 inches.

The present invention is also directed to an method for imaging an area of an object positioned behind a light transmissive structure (e.g., eyeglasses) using illuminators which produce specular reflections on the eyeglasses while avoiding specular reflections from falling onto an area of the object to be imaged. An exemplary method includes the steps of: providing a first lens system; providing a second lens system positioned a predetermined distance from the first lens system; providing a first illuminator positioned outboard of the second lens system for operating with the first lens system to capture an image of either a left eye or a right eye; providing a second illuminator positioned outboard of the first lens system for operating with the second lens system to capture an image of either a left eye or a right eye; separating the first illuminator from the first lens system a distance apart from one another to ensure a minimum angular separation so that no reflections due to eyeglasses fall within an iris image area; separating the second illuminator from the second lens system a distance apart from one another to ensure a minimum angular separation so that no reflections due to eyeglasses fall within an iris image area; illuminating the area with the first illuminator and checking to see if the first illuminator has produced a specular reflection that obscures the area of the object; if the first illuminator has produced a specular reflection that obscures the area of the object then illuminating the area with the second illuminator; obtaining an image of the area while the first illuminator is on using the first imager if the first illuminator has produced a specular reflection that has not obscured the area; and obtaining an image of the area while the second illuminator is on using the second imager if the first illuminator has produced a specular reflection that has obscured the area.

The method also includes separating the first illuminator from the first lens and separating the second illuminator from the second lens system a distance sufficient to ensure a minimum angular separation of about 11.3 degrees. In addition, the method includes the step of expanding an apparent capture volume defined by dimensions X, Y, and Z, wherein the expanded capture volume is formed by extending a dimension of the capture volume in one or more of an X-axis, a Y-axis, and a Z-axis.

Other features of the invention are described below.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific methods and instrumentalities disclosed. In the drawings:

FIG. 1 shows a prior art iris image capture device having a relatively small iris capture volume;

FIG. 2 shows an exemplary iris image capture device having an expanded capture volume in accordance with the present invention;

FIG. 3 shows a schematic view of the iris image capture device of FIG. 2;

FIGS. 4A-4E shows an exemplary user interface that can be used with the iris image capture device of the present invention;

FIGS. 4F-4J shows another exemplary user interface that can be used with the iris image capture device of the present invention;

FIG. 5 shows a functional block diagram of the iris image capture device of FIG. 2;

FIG. 6A shows an exemplary camera layout of an iris image capture device that enables two-eye iris authentication, which supports an expanded capture volume;

FIG. 6B shows the exemplary camera layout of FIG. 6A with a Wide Field Of View (WFOV) camera;

FIG. 7A shows an exemplary eye geometry with two capture areas overlaid for each eye;

FIG. 7B shows the exemplary eye geometry with two capture areas overlaid for each eye of FIG. 7A with exemplary dimensions;

FIG. 8 shows an exemplary moment of iris image capture for the right eye;

FIG. 9 shows how the left eye can be successfully captured by the right capture volume if the user's head is shifted;

FIG. 10A illustrates how an image of the left iris can be captured when the user's head is shifted to the right up to the right maximum position;

FIG. 10B illustrates how an image of the right iris can be captured when the user's head is shifted to the left up to the left maximum position;

FIG. 11 illustrates that the object distance of each Narrow Field Of View (NFOV) channel can be offset from one another in the Z-axis resulting in the apparent capture volume expanding along the Z-axis;

FIG. 12 illustrates an exemplary apparent composite capture volume in accordance with the present invention;

FIG. 13 shows the fuller potential of offsetting the capture volumes from one another as the F/# of the lens increases;

FIG. 14 illustrates the resultant apparent composite volume resulting from the configuration of FIG. 13;

FIG. 15 shows an exemplary embodiment having a minimum angular separation for successfully capturing an iris image through eyeglasses;

FIG. 16 shows an exemplary partially silvered mirror user interface with user position feedback that can be used with the iris image capture device of the present invention;

FIG. 17 is a side view of the partially silvered mirror user interface of FIG. 16 showing an exemplary backlit interface and a user's eyes; and

FIG. 18 shows a schematic view of an exemplary iris image capture device having the lens systems positioned behind a partially silvered mirror.

### DETAILED DESCRIPTION OF THE PREFERRED EMBODIMENTS

The present invention relates to an apparatus, system, and method for capturing an image of an iris of an eye that achieve an expanded iris image capture volume to enable greater ease of use, has no moving parts thereby enhancing reliability, achieves low cost through use of a simple design and commonly available imaging components, and overcomes the problem of eyeglass reflections to avoid/reduce false rejections. The capture volume can be expanded by extending the iris image capture zone in one or more axes (X, Y, and/or Z). Preferably, the capture volume is expanded by extending the iris image capture zone along the Z axis, which results in an expanded capture volume. More preferably, the capture volume is expanded by extending the iris image capture zone along the Z axis and the X axis, which further expands the capture volume. The invention is also directed to an apparatus, system, and method for illuminating and imaging an iris of an eye through eyeglasses using the iris image capture device of the present invention. In addition, an improved user interface can be provided to further improve ease of use of the iris image capture device.

Introduction of the Expanded Capture Volume:

Wide, public acceptance of iris authentication technology and iris authentication products is in large part determined by its ease of use. A fast and nearly effortless experience is highly desirable. Generally, ease of use includes a minimal initial training or instruction to the point that ideally a device and process is so intuitive that no training materials or instructions are needed. One specific factor that contributes not only to lowering the initial threshold but also the recurring ease of use is the size of the capture volume. Ease of use improves as the capture volume expands.

The capture volume is the tangible but invisible volume where iris image capture is designed to occur. It is the volume where there is a convergence of three necessary elements: 1) light, which can be near-infrared illumination supplied from a camera; 2) the camera's field of view (FOV), which can be expressed in X and Y dimensions at the object plane; and 3) the range where the image is in focus as determined by the lens' object distance and depth of field, which can be expressed in a Z dimensions or range.

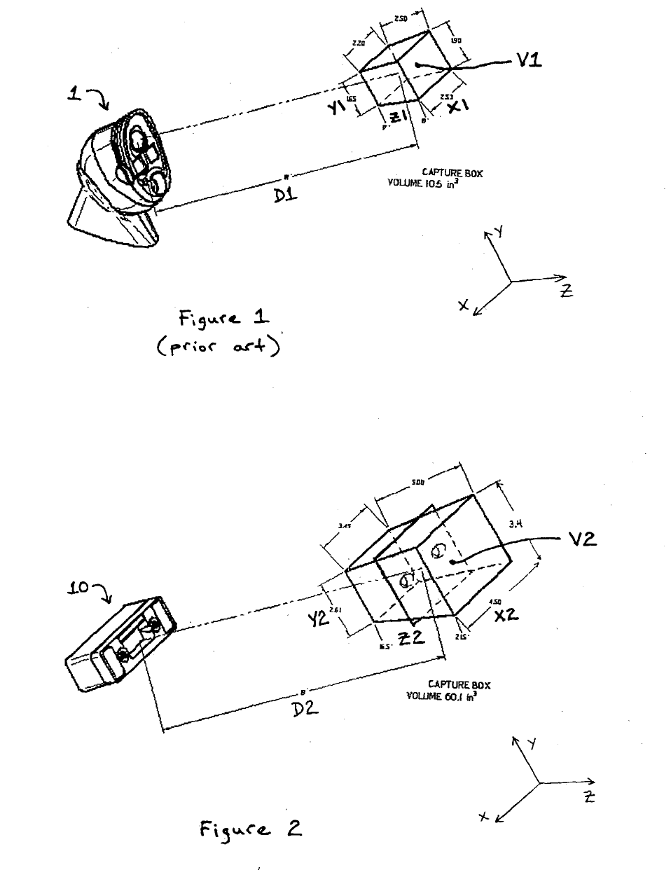

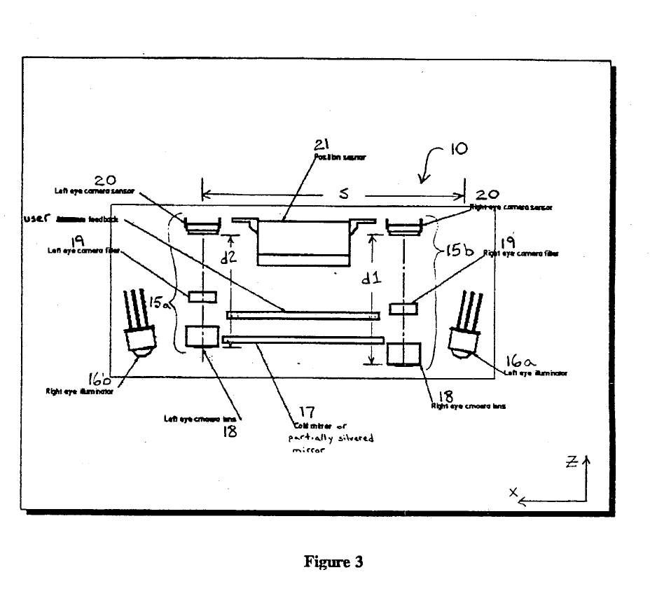

FIGS. 1 and 2 each show an iris capture device having an iris capture volume. FIG. 1 shows a conventional iris capture device 1 including a single camera and illuminator and having a relatively small capture volume. As shown in FIG. 1, the capture volume has dimensions X1, Y1, and Z1 defining capture volume V1. The capture volume V1 is located a distance D1 from the iris capture device 1.

FIG. 2 shows an exemplary iris capture device 10 including at least two cooperating lens systems and illuminators and having an expanded capture volume. As shown in FIG. 2, the expanded capture volume has dimensions X2, Y2, and Z2 defining volume V2 that is larger than the capture volume V1 of FIG. 1. The expanded capture volume V2 is located a distance D2 from the iris capture device 10.

As can be appreciated, the iris capture device 10 having expanded capture volume V2 of FIG. 2 is easier to use than the prior art device 1 having the relatively small capture volume V1 of FIG. 1, because a user is burdened less to position his or her eye into the larger capture volume of expanded capture volume V2. Although position feedback can be provided to further help position the user precisely, as discussed below, the relationship still remains that the iris authentication experience improves proportionally with the size of the iris image capture volume.

The ease of use as a function of the iris capture volume can be further broken down into each of the three axes of the capture volume X, Y, and Z, as represented by a Cartesian coordinate system depicted in FIG. 2. X represents the width of the capture volume (e.g., right and left), Y represents the height of the capture volume (e.g., up and down), and Z represents the depth of the capture volume (e.g., in and out). As can be appreciated by one skilled in the art and from FIGS. 1 and 2, the iris image capture zone is a box-like volume, however, the dimensions of the capture zone increase as the distance D from the iris imaging device increases.

As any of the dimensions (X, Y, Z) within the volume increases, the capture zone extends in that direction and the entire capture volume expands accordingly. As the capture volume expands due to an increase in any one or combination of axes, the user finds the overall ease of use improves proportionally. Therefore, the challenge for designing iris imaging devices has been and continues to be growing the capture volume as large as possible within the universal design constraints of cost, available power, complexity, number of parts, assembly time, physical size, and the like.

The present invention provides an apparatus, system, and method for expanding the iris image capture volume by increasing one or more dimensions (X, Y, Z). In one embodiment, the Z dimension is increased to extend the capture zone in the Z direction, which results in an expanded iris capture volume. In another embodiment, the X dimension and the Z dimension are increased to extend the capture zone in the X and Z direction, which results in an expanded iris capture volume. The Y dimension can also be increased, if desired.

Iris Image Capture Device:

FIG. 3 shows the exemplary iris capture device 10 of FIG. 2 illustrating an exemplary component layout. As shown in FIG. 3, the iris capture device 10 includes at least two lens systems 15, at least two illuminators 16, and a user interface 17.

As shown in FIG. 3, the at least two lens systems 15a, 15b (also referred to herein as imager and camera) include a first lens system 15a second lens system 15b. As shown, each lens system 15a,15b includes a camera lens 18, a filter 19, and a sensor 20.

Preferably the first lens system 15a and the second lens system 15b are positioned so that they are on-axis to the eyes of a user. For example, when the user is positioned in front of the iris image capture device and is looking straight ahead, the first lens system 15a is preferably on-axis with the left eye 30a and the second lens system is preferably on-axis with the right eye 30b. More preferably the first lens system 15a and the second lens system 15b are separated by a distance in the X-axis corresponding to the average eye separation of typical users of the iris image capture device.

Preferably, each lens system 15a,15b includes a single element lens camera. The camera lenses 18 can be the same type of lens or may be different types of lens that are selected to provide a desired range or depth of focus over the applicable Z dimension of the iris image capture zone. Providing a desired range or depth of focus can be achieved by physically offsetting the lens systems or optically offsetting the lens systems.

For example, in one embodiment, the left eye camera lens can include a lens design having a working distance centered at about 17 inches, a horizontal field of view of about 1.9 inches, and a pixel density (pixels per 11 mm iris diameter) of about 150, and the right eye camera lens can include a lens design having a working distance centered at about 20 inches, a horizontal field of view of about 1.9 inches, and a pixel density (pixels per 11 mm iris diameter) of about 150. In this embodiment, the left eye camera lens has a distance dl between the front of the lens to its image sensor of about 36 mm and the right eye camera lens has a distance d2 between the front of the lens to its image sensor of about 41 mm. Increasing the range or depth of field results in an extended capture zone in the Z dimension because one or both eye will be in focus over a greater Z dimension.

Although not required, each lens system may include a filter 19, as shown in FIG. 3. In embodiments having a filter, preferably an optical long-pass filter is used to filter out environmental light, such as, for example, environmental light that may be reflected off of the wet layer of the cornea of the eye.

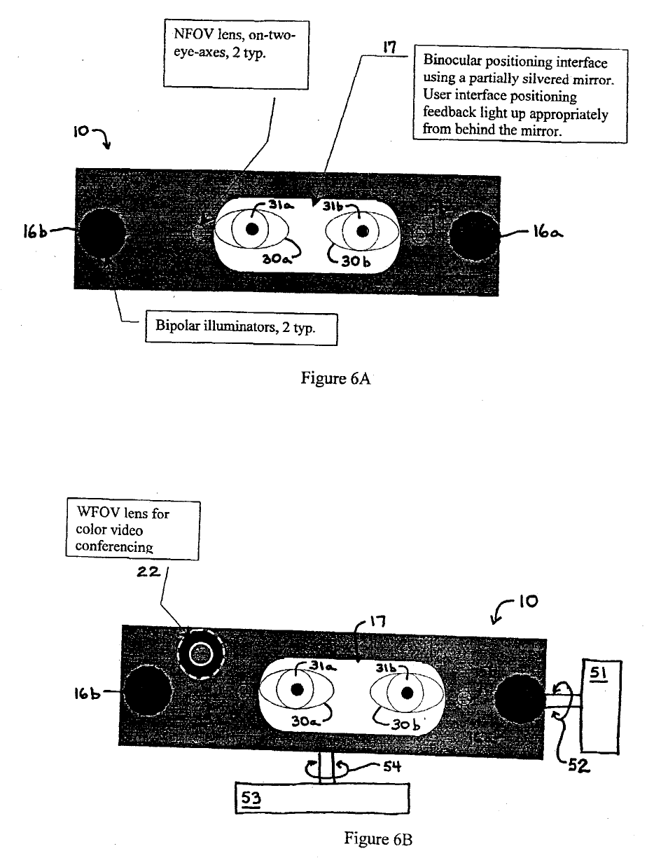

The sensor 20 can include any conventional imaging device, such as a CCD, a CMOS sensor, or the like. Preferably, the sensor supports a wide array of resolutions, including VGA, SVGA, XGA, SXGA, and the like. The higher the resolution of the sensor 20, the greater the camera FOV (see FIG. 6A), and hence the greater the X, Y dimensions of the iris image capture volume. One suitable sensor includes a progressive scan CCD image sensor with square pixel for color cameras, part number ICX098AK, manufactured by SONY®.

As shown in FIG. 3, the at least two illuminators 16a,16b include a first illuminator 16a and a second illuminator 16b. As shown in FIG. 3, the first illuminator 16a is located outboard of the second lens system 15b and the second illuminator 16b is located outboard of the first lens system 15a.

In a preferred embodiment, the first lens system 15a cooperates (e.g., operates) with the first illuminator 16a and the second lens system 15b cooperates (e.g., operates) with the second illuminator 16b. Each lens system and illuminator combination 15a/16a and 15h/16b has a separation S in the X-axis.

Each of the at least two illuminators 16a,16b can include a single illumination source or an array of individual illumination sources. The illuminator can include any suitable source of illumination, such as a Laser, Infrared or near Infrared emitter, an LED, neon, xenon, halogen, fluorescent, and the like. Preferably, the illuminators 16a,16b are near Infrared illuminators.

Preferably, each illuminator is made as small as possible. Making the illuminators as small as possible helps reduce specularities caused by light reflecting off, for example, eyeglasses because the amount of specularity is proportional to the source size. Also, the smaller the illuminator source, the closer the camera and illuminators can be located with respect to one another, and thus the smaller the physical size of the iris image capture device 10.

The user interface 17 helps a user position him or herself generally with respect to the iris image capture device 10. The user interface 17 indicates to the user where he or she is with respect to where he or she is supposed to be in order to be in the expanded image capture volume V2. The user interface 17 can include a variety of components including visual and/or audio indicators such as, for example, a binocular positioning interface (e.g., a reflective mirror, a cold mirror, or a partially silvered mirror), positioning feedback light indicators (e.g., LEDs); speakers, and the like, that the user interacts with in order to better position him or herself with respect to the iris image capture device 10.

The iris image capture device 10 can also include a variety of components for helping to adjust the iris image capture device 10 with respect to the position of the user. For example, the iris image capture device 10 can include one or more of a Position Sensitive Device (PSD) 21, a Pyro-electric Infrared (PIR) detector (not shown), a Wide Field Of View (WFOV) camera 22 (see FIG. 6B), etc. A PSD 21 senses the Z position of the user and the output from the PSD can be coupled to an indicator that indicates to the user which way to move in order to assist the user in positioning him or her self with respect to the iris image capture device in the Z dimension. For example, the indicator could indicate that the user should move towards or away from the device. Preferably, the PSD is impervious to color and reflectivity of reflective objects, has a transmitter and a receiver, has low power consumption, and has low heat.

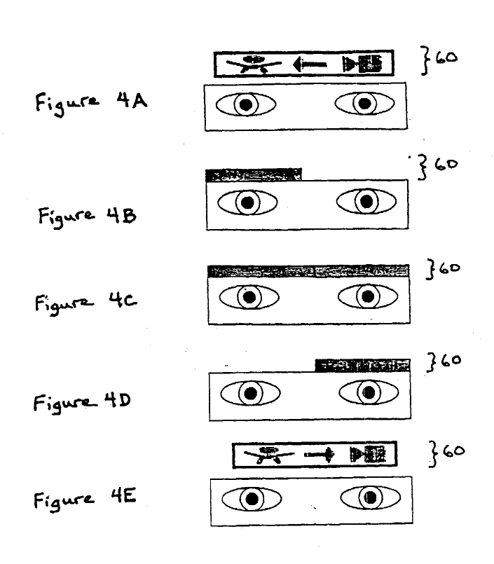

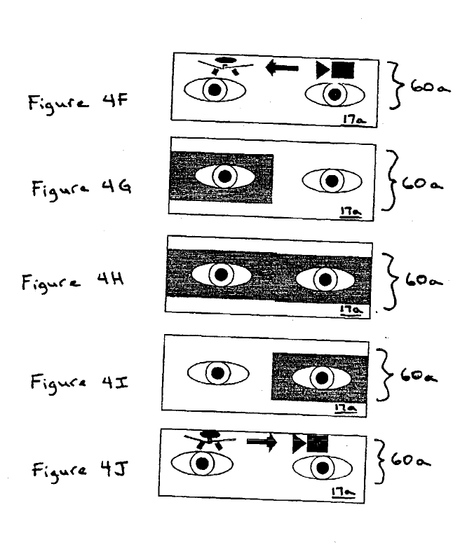

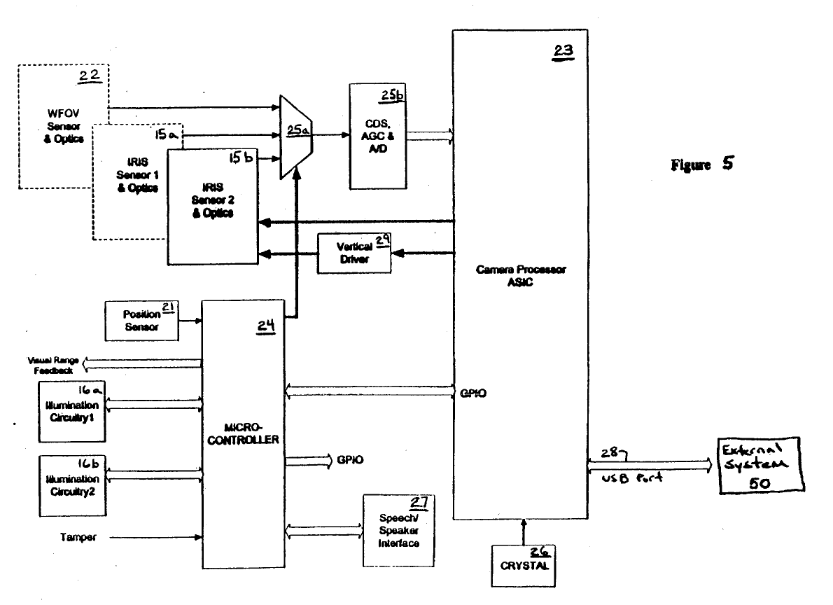

FIGS. 4A-4J show exemplary user interfaces that can be used with the iris image capture device of the present invention. The user interface 17 preferably includes a feedback mechanism that indicates to the user where they are in relation to the iris image capture device and the capture volume V2.

FIGS. 4A through 4E show an exemplary user interface 17 including a position display and logic. As shown in FIGS. 4A-4E, the user interface 17 can include a graphic display 60 and a color display (color not shown) to assist the user in positioning himself or herself in the capture volume V2. FIG. 4A shows that both eyes are out of position and that the user needs to move away from the iris image capture device 10 in order to be properly positioned. FIG. 4B shows the left eye in position and the right eye is close but still out of position. FIG. 4C shows both eyes in position. FIG. 4D shows the right eye in position and the left eye close but still out of position. FIG. 4E shows both eyes out of position and indicates that the user needs to move toward the iris image capture device in order to be properly positioned. The indicators can be in color to further enhance the visual indications. For example, green could be used to indicate to the user that an eye is in the iris image capture volume V2, yellow could be used to indicate that an eye is close to being in the capture volume V2, and red or orange could indicate that an eye is out of the iris image capture volume V2.

FIGS. 4F through 4J show another exemplary user interface 17 wherein the position display and logic are disposed behind a partially silvered mirror 17a. In this embodiment, the graphics display 60 can include an LCD with one or more of text and graphics that can be selectively displayed to the user through the partially silvered mirror 17a. FIG. 4F shows that both eyes are out of position and that the user needs to move away from the iris image capture device 10 in order to be properly positioned. FIG. 4G shows the left eye in position and the right eye is close but still out of position. FIG. 4H shows both eyes in position. FIG. 4I shows the night eye in position and the left eye close but still out of position. FIG. 4J shows both eyes out of position and indicates that the user needs to move toward the iris image capture device in order to be properly positioned

FIG. 5 is an exemplary functional block diagram for the iris image capture device 10. As shown in FIG. 5, the iris image device 10 includes a camera processor (ASIC) 23 and a micro-controller 24. As shown, the first and second lens systems 15a, 15b, and a WFOV sensor and optics 22 are coupled to the camera processor 23, preferably through a multiplexer 25a and a device 25b having one or more of Correlated Double Sampling (CDS), Automatic Gain Control (AGC), and an Analog to Digital (A/D) conversion device. A vertical driver 29 can be provided to change the voltage levels of the timing signal between the camera ASIC and the CCD sensors. The illumination circuitry 16a,16b is coupled to the micro-controller 24. The position sensor 21 is also coupled to and controlled by the micro-controller 24. The micro-controller 24 and the camera processor can communicate via an interface, such as, for example, a General Purpose Input/Output (GPIO) interface. A user interface can be provided, such as speech/speaker interface 27, a visual range feedback (e.g., an LED or LCD), etc. A clock 26 can be provided to synchronize and time the various components of the image capture device 10, such as a crystal. A power source (not shown) is provided to supply power to the various components of the iris image capture device 10. The iris image control system includes a communication port 28, such as a USB port, for communicating with an external system 50, such as a personal computer. Preferably, the external system 50 has a processor for performing iris image comparisons and a database for storing iris images.

Extending the X Axis:

FIG. 6A shows an exemplary layout of the iris image capture device 10 that enables two-eye iris authentication. As shown in FIG. 6, the layout of the iris image capture device 10 supports an apparent increase in the width of field, and also supports an apparent increase in the depth of field (shown and discussed later). FIG. 6A shows how the two lens systems 15a, 15b (e.g., narrow field of view (NFOV) cameras and lenses) and two illuminators (e.g., bipolar) 16a, 16b can be arranged to capture either or both a left eye 30a and/or a right eye 30b.

As shown in FIG. 6B, the iris image capture device 10 can include a WFOV camera 22 that can be used to locate the user and the location of the user's eyes. The output from the WFOV camera 22 can be used to adjust the position of the iris image capture device 10. A tilt mechanism 51 can be provided to adjust the iris image capture device 10 up and down, as indicated by arrow 52. Also, a pan mechanism 53 can be provided to adjust the iris capture device 10 side to side, as indicated by arrow 54. For embodiments having one or more of a tilt mechanism 51 and a pan mechanism 53, these functions can be controlled using the output from the WFOV camera 22. An iris image capture device 10 having tilt and/or pan features further improves ease of use.

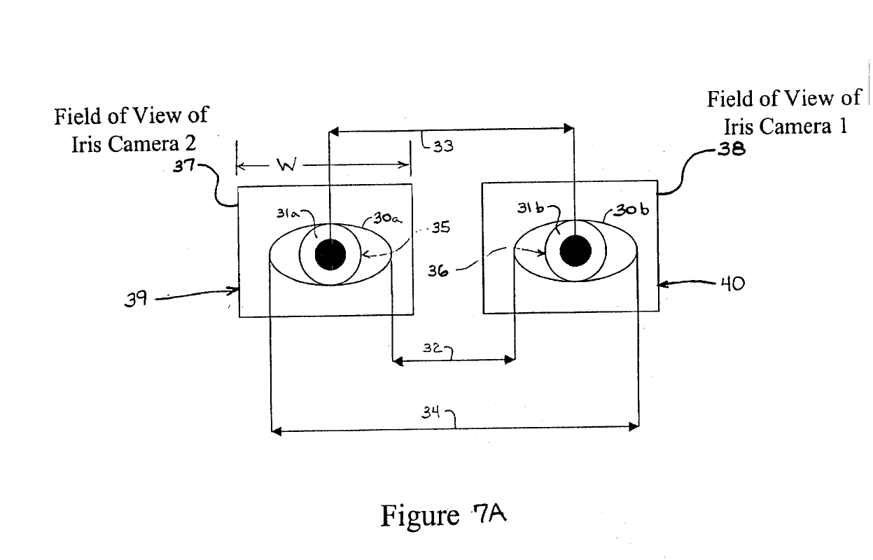

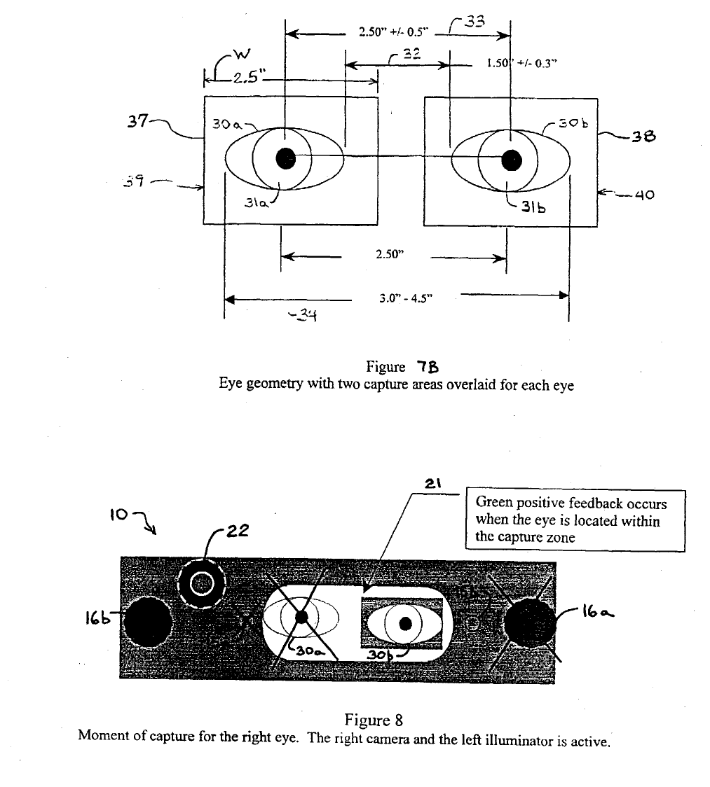

FIG. 7A shows an exemplary eye geometry including a left eye 30a having left iris 31a and a right eye 30b having right iris 31b. As shown in FIG. 7A, the eye geometry includes a minimum eye boundary separation 32, an average eye or iris separation 33, a maximum eye boundary separation 34, a left iris inner boundary 35, and a right iris inner boundary 36. The iris image capture field of view (FOV) geometry includes a left FOV 37 corresponding to the first lens system 15a, a right FOV 38 corresponding to the second lens system 15b, a FOV width W, a left FOV outer boundary 39, and a right FOV outer boundary 40. The size of the FOVs 37, 38 is dependent, in part, on the resolution of the sensor and the optics of the lens systems 15a,15b.

FIG. 7B shows exemplary dimensions for the various geometry features of FIG. 7A. The dimensions shown in FIG. 7B are for exemplary purposes only, and are not intended to limit the present invention in any way. As shown, the minimum eye boundary separation 32 is about 1.50±0.3 inches, the average eye or iris separation 33 is about 2.50±0.5 inches, and the maximum eye boundary separation 34 is between about 3.00-4.50 inches.

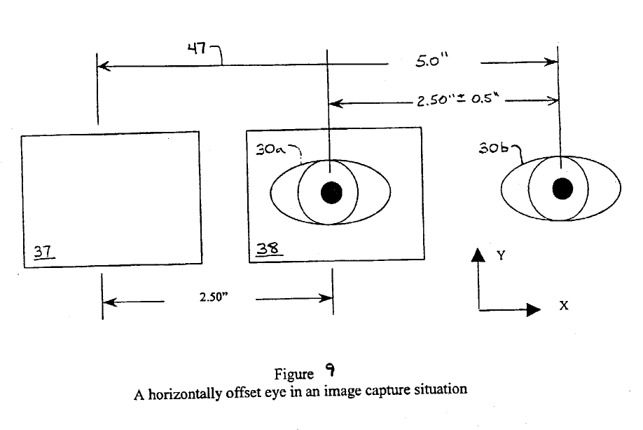

FIG. 8 shows the moment of capture for the right eye 30b. While both eyes are seen and positioned in the mirror 45 the second camera 15b and the second illuminator 16b operate to capture the iris image. The inactive elements (e.g., the first lens system 15a and the first illuminator 16a) are shown ‘X’ed out.

Note that the design of a two-eye iris (irides stated correctly) authentication system, that either (single) eye can also be used for authentication. That is, while capturing the second eye produces additional benefits, only a single iris is necessary to complete a high confidence authentication transaction.

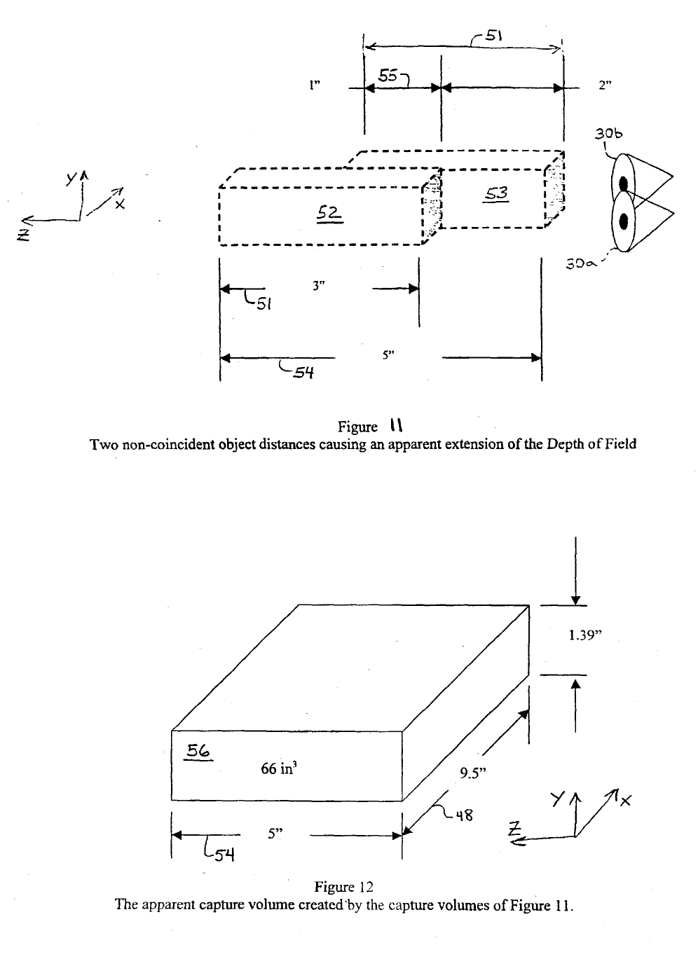

FIG. 9 shows how the user's head can be shifted so that the left eye 30a could be successfully imaged by the right capture volume 38. While the user interface is designed for seeing both eyes in the mirror (see FIG. 6A), there is nothing precluding the system from operating in that manner. Likewise, that the right eye 30b can be imaged in the left capture box 37. The net result is that the apparent width of view 48 in the horizontal axis (e.g., the X axis) is extended resulting in an expanded capture volume V2 (see FIG. 12). So, for the exemplary eye geometry and dimensions illustrated in FIG. 7B, the apparent width of field 48 expands in the X axis by more than about 5 inches (greater than about 2.5 inch average eye or iris separation plus greater than about 2.5 inch right shift) as the left eye 30a can be captured in the right volume 38. The same is true regarding the right eye 30b, which can be captured in the left volume 37. This composite exemplary extension (not shown) of the apparent capture volume in the X axis is about 7.5 inches (e.g., adding greater than about 2.5 inch left shift to the about 5 inches above) assuming that the left eye 30a is positioned and captured in the center of the right FOV 38 or the right eye 30b is positioned and captured in the center of the left FOV 37 (see FIG. 12).

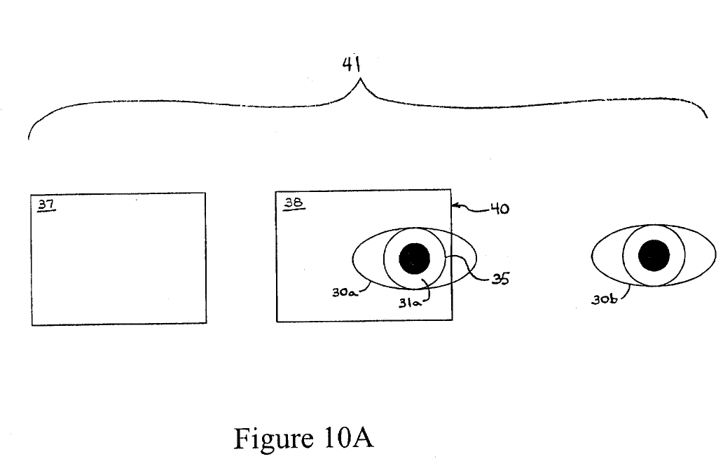

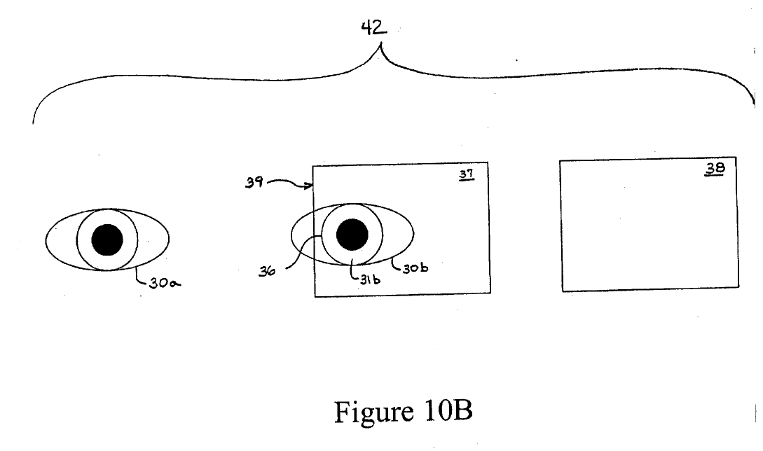

Referring to FIGS. 10A and 10B, the capture zone in the X-axis can be extended even further due to the geometry and position of the two lens systems 15a, 15b and the two illuminators, and the geometry of the FOVs 37, 38. A maximum extension of the X axis can be achieved by capturing an image of one of the left eye 30a or the right eye 30b anywhere between a first shifted position 41 (shown in FIG. 10A) where the left iris inner boundary 35 is located proximate the right FOV outer boundary 40 and a second shifted position 42 (shown in FIG. 10B) where the right iris inner boundary 36 is located proximate the left FOV outer boundary 39. As shown in FIGS. 12 and 14, a maximum apparent width of field 48 results and includes the distance between the first shifted position 41 (shown in FIG. 10A) and the second shifted position 42 (shown in FIG. 10B).

As shown in FIG. 10A, an image of the left iris 31a can be captured when the user's head is shifted to the right up to the right maximum position where the left iris inner boundary 35 is located juxtaposition the night FOV outer boundary 40. Also, as shown in FIG. 10B, an image of the right iris 31b can be captured when the user's head is shifted to the left up to the left maximum position where the right iris inner boundary 36 is located juxtaposition the left FOV outer boundary 39. The net result is that the apparent width of field 48 extends to a maximum dimension, limited only by the geometry of the iris image capture device and the FOV geometry, in the horizontal axis (e.g., X axis). As a result of the increase in the apparent width of field 48 in the X-axis, the overall capture volume V2 expands.

Extending the Z Axis:

The capture volume V2 can also be extended in the Z-axis by physically offsetting the lens systems 15a,15b and/or optically offsetting the lens systems 15a,15b. FIG. 11 shows that the object distance 51 of each NFOV channel of lens systems 15a, 15b can be off set from one another in the Z-axis. As shown in FIG. 11, the capture volume V2 includes a first NFOV channel 52 associated with the first lens system 15a and a second NFOV channel 53 associated with the second lens system 15b. Each channel 52,53 has a depth of field 51 or range in the Z direction. By offsetting the first NFOV channel 52 from the second NFOV channel 53 an apparent depth of field 54 can be created. As a result, to the user the camera system will operate and perform over the apparent depth of field 54 range as opposed to only each channel's depth of field 51 range.

Preferably, an overlap 55 is included between the first NFOV channel 52 and the second NFOV channel 53. Preferably, the overlap 55 is minimized for any given application, which results in an increase in the apparent depth of field 54. Although the camera system can be set up so that there in no overlap 55, preferably there is at least some overlap 55 to ensure that at least one of the NFOV channels 52, 53 has an eye 30a, 30b in focus over the entire depth of field. An opposite situation may be preferred wherein the overlap is maximized so that both eyes can be imaged for applications where a higher performance verification or identification is desired.

FIG. 11 includes some exemplary dimensions to illustrate the extended capture zone in the Z-axis. The dimensions shown are for exemplary purposes only and are not intended to limit the scope of the present invention in any way. In the example shown in FIG. 11, each channel's Depth of Field 51 is about 3 inches. By offsetting the first NFOV channel 52 from the second NFOV channel 53 with about a 1 inch overlap 55, about 5 inches of apparent depth of field 54 can be created. As a result, to the user the camera system will operate and perform over about a 5 inch range as opposed to only about a 3 inch range.

The resultant composite capture volume 56, including both the apparent width of field 48 and apparent depth of field 54, is shown in FIG. 12. The offset design having an extended Z-axis can be created, for example, by using a different lens prescription on the first lens system 15a and the second lens system 15b and/or by physically offsetting the first lens system 15a and the second lens system 15b (see FIG. 3).

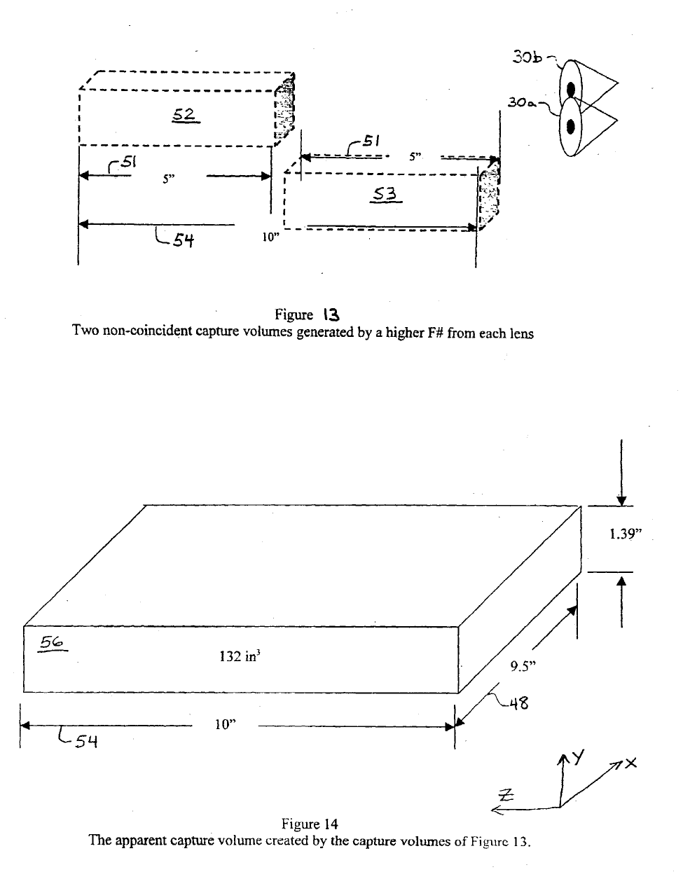

FIG. 13 indicates the fuller potential of offsetting the capture volumes of the individual camera channels 52,53 from one another as the F/# of the lens is increased. With a higher lens F/# for each lens, each depth of field 51 increases and when the two are further designed to overlap minimally, a very large apparent depth of field 54 can be created. Alternatively, the system design can include a combination of a physical and an optical offset. This relatively large apparent depth of field 54 created by either a physical and/or optical offset provides a small, low cost, static design that rivals much larger, more expensive, and complex autofocusing lenses.

The resultant composite capture volume 56 is shown in FIG. 14. Also, it is worth noting that this design does not preclude adding autofocusing capability to the already extended depth of field 54 to further extend it. This offset design magnifies autofocusing capability.

In addition, if desired, the lens systems and illuminators could be offset vertically in the Y-axis to achieve an apparent height of field (not shown) in the Y-axis. For example, a third lens system and a third illuminator (not shown) can be positioned such that they are vertically offset in a Y-axis from the first lens system, the second lens system, the first illuminator, and the second illuminator to form an apparent expanded capture volume along the Y-axis. An expanded apparent capture volume is formed along the Y-axis by extending an apparent height of field by offsetting the height of field of each lens system from one another.

The offset design in the Z-axis also reduces a magnification design challenge. Iris authentication requirements typically restrict the iris image diameter to a minimum and a maximum for software to successfully operate. As the user moves in the ‘Z’ direction (in and out), the image is naturally magnified as the user is closer and is reduced as the user moves away from the camera. The offset design reduces this problem by a discrete step as the offset occurs. For example, as the user moves in toward the camera the second lens system 15b images an ever-reducing iris size of the user's right eye 30b in the right or further capture volume (the first capture volume 52 as shown in FIGS. 11 and 13) until the users left eye 30a enters the left or closer volume (the second capture volume 53 of FIGS. 11 and 13) at which time the first lens system 15a images an ever-reducing iris size of the user's left eye 30a. The first lens would magnify the left eye to the large size as the user is farthest out in the left volume then reduce in size as the user continues to move toward the camera. Effectively, the offset design can double the range that otherwise constitutes the end points of the range where minimum and maximum magnification occur.

Introduction of the Use with Eyeglasses:

The iris image capture device 10 of the present invention also provides a valuable variation of an embodiment that achieves successful iris authentication for use with eyeglasses. U.S. Pat. No. 6,055,322, entitled “Method and Apparatus for Illuminating and Imaging Eyes through Eyeglasses using Multiple Sources of Illumination”, describes a method and apparatus for overcoming the problem of reflections due to eyeglasses in iris imaging systems. U.S. Pat. No. 6,055,322 describes how an iris imaging apparatus can be designed and constructed to successfully illuminate and image the eye through eyeglasses for iris authentication using multiple illuminators with a single imager. This reference is incorporated herein by reference in its entirety.

One embodiment of the present invention includes a single illuminator and a single lens system positioned a known distance apart and having a sufficient minimum angular separation a to ensure no reflections due to eyeglasses fall within the iris image area. Another embodiment uses a single illuminator and multiple lens systems each positioned a predetermined distance from the illuminator to ensure that at least one lens system will have no reflections due to eyeglasses fall within the iris image area.

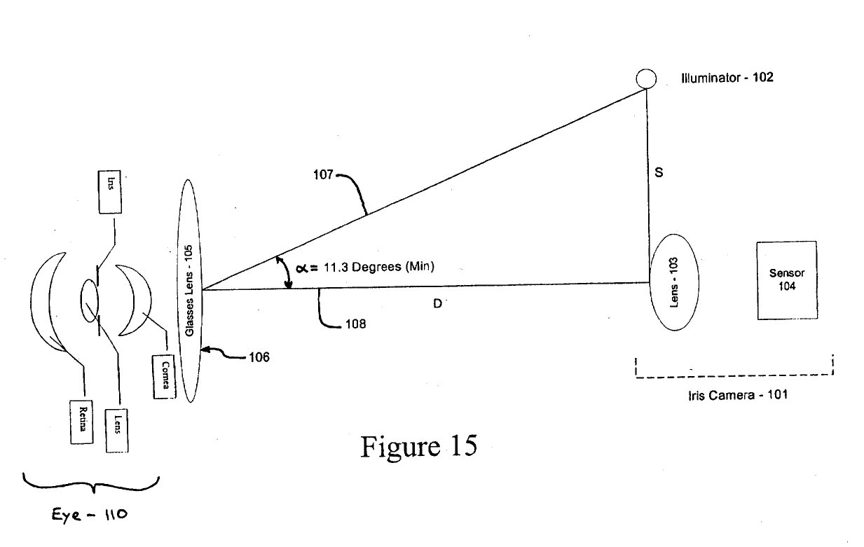

FIG. 15 shows an iris imaging device 100 having a single lens system 101 and a single illuminator 102. As shown in FIG. 15, the lens system includes a lens 103 and a sensor 104. The lens system 101 and the illuminator 102 are positioned having predetermined separation S. The user's eye 110 is position behind a light transmissive structure 105, such as, for example, eyeglasses. A user distance D defines the distance between the outer surface 106 of the user's eyeglasses 105 and the front of the lens system 101. An angular separation is defined by an angle α formed by a line 107 from the illuminator to the eyeglasses (representing the illuminator axis) and a line 108 from the eyeglasses 105 to the lens 103 of the lens system 101 (representing the camera axis). This geometry of ensuring a minimum angular separation α ensures no eyeglass specularities fall onto the iris image.

Ensuring that eyeglass specularities do not fall onto the iris image can be achieved by maintaining a minimum angular separation a of about 11.3 degrees. The minimum angular separation α of about 11.3 degrees can be ensured by manipulating the separation S between the illuminator and the NFOV lens and the user distance D. For example, it has been shown that providing a predetermined separation S between the illuminator and the NFOV lens of at least about 6 inches ensures that all large specularities do not fall onto the iris image area, out to a user distance of about 30 inches.

The iris authentication for use with eyeglasses methodology has been shown to be an effective method to deal with the eyeglass specularity problem for iris authentication. Conventional iris imagers for capturing an iris image through eyeglasses typically have one camera and two or three illuminators. U.S. Pat. No. 6,055,322 describes a method to ensure that specularites do not contaminate iris information by the geometry of separating two illuminators supporting a single camera to image a single eye. However, this conventional iris imaging methodology for capturing an iris image through eyeglasses suffer from the same problems discussed above associated with a relatively small capture volume.

The iris image capture device 10 of the present invention provides an iris imager that solves the problems associated with the relatively small capture volume and also the problems associated with reflections off eyeglasses by providing at least two cameras and at least two illuminators including a geometry that ensures a minimum angular separation a of at least about 11.3 degrees. That is, a single illuminator set (right side or left side) is used to provide illumination for a single corresponding lens system (e.g., camera) having a separation S between each set of corresponding lens systems and illuminators, which ensures the minimum angular separation α. By inspection, the method will work as long as the camera to illuminator separation meets a minimum geometry.

This concept of providing a minimum angular separation a can also be used in the embodiment shown in FIG. 6. FIG. 6 shows two NFOV lenses and two sets of illuminators each outboard of the NFOV lenses. In this embodiment, the operation of the iris image capture device can be so that when the second imager 15b is operating the second illuminator set 16b is illuminating and vise versa. This arrangement of a single illuminator operating with a single camera functions in a similar manner as the arrangement shown in FIG. 15 to avoid eyeglass specularities from falling onto the iris image, providing that a minimum angular separation a of about 11.3 degrees is ensured, as described above. Again, this is accomplished by basic geometry and by ensuring the minimum angular separation α.

Preferably, the minimum geometry equates to about 11.3 degrees of separation between the illuminator axis and the NFOV camera axis. This assumes that the user's head the eye are looking at a particular point (e.g., the users interface or mirror). Table 1 indicates the minimum separation S at various user distances D to achieve 11.3 degrees of separation.

TABLE 1
Illuminator and camera separation to achieve 11.3
degrees of separation

| Item | User distance to camera | Illuminator and NFOV camera |
|---|---|---|
| No. | (inches) | separation (inches) |
| 1 | 6 | 1.2 |
| 2 | 8 | 1.6 |
| 3 | 10 | 2.0 |
| 4 | 12 | 2.4 |
| 5 | 14 | 2.8 |
| 6 | 16 | 3.2 |
| 7 | 18 | 3.6 |
| 8 | 20 | 4.0 |
| 9 | 22 | 4.4 |
| 10 | 24 | 4.8 |
| 11 | 26 | 5.2 |
| 12 | 28 | 5.6 |

Referencing FIGS. 6A and 6B, it follows that when the left illuminator set illuminates the right eye, a minimum of about 2.5 inches of separation is guaranteed because the illuminators are positioned outboard from the NFOV cameras. The same is true for the other right-left combination. However, greater separation beyond about 2.5 inches may be required as the user moves further away from the camera. Table 2 indicates the width necessary as the user distance increases.

TABLE 2
Illuminator and camera separation to achieve 11.3
degrees of separation

| Item | User distance to | Illuminator and NFOV | Unit width |
|---|---|---|---|
| No. | camera (inches) | camera separation (inches) | (inches) |
| 1 | 14 | 2.8 | 4.75 (standard) |
| 2 | 16 | 3.2 | 4.75 (standard) |
| 3 | 18 | 3.6 | 5.2 |
| 4 | 20 | 4.0 | 5.6 |
| 5 | 22 | 4.4 | 6.0 |
| 6 | 24 | 4.8 | 6.4 |
| 7 | 26 | 5.2 | 6.8 |

One major benefit of this variation of using two cameras with two active illuminator sets, is that a much smaller package can be achieved than would otherwise be possible with only one imager.

A smaller specularity can become acceptable to the iris authentication process, provided it is sufficiently small. For example, it is known that less than about 5 percent eyeglass specularity (percent iris image area occluded) causes an increase of less than about 1 percent False Rejection Rate, and a 10 percent eyeglass specularity causes an increase of less than about 4 percent False Rejection Rate. Due to the geometries associated with separating the illuminators from the cameras, only the small specularity encroaches the iris image for all eyeglass prescriptions. For the minimum width geometry provided in Table 2, all large specularites are sufficiently far away from the iris and in some of the higher diopter eyeglasses, even the small specularities are off the iris.

The User Feedback Interface:

As discussed above, wide, public acceptance of iris authentication technology and iris authentication products is in large part determined by its ease of use. Another factor that contributes not only to lowering the initial threshold but also the recurring ease of use is the user feedback interface. One factor involved in getting high quality images is ensuring that the subject is looking directly into the camera. Previous approaches usually forced the individual to redirect their gaze away from the iris camera to get necessary feedback information.

For example, LEDs, mirrors, holograms, and video displays have been used in conventional feedback systems to convey feedback information such as: accept the user, reject the user, move forward, move backward, move right, move left, etc.

This new user interface improves upon some of these ideas. Referring back to FIG. 6A, the iris image capture device 10 can include a partially silvered mirror 17a positioned between the two lens system 15a, 15b. By using a partially silvered mirror 17a as the focal point for the user, a plethora of information can be communicated through the mirror without redirecting the user's gaze away from the iris camera. The partially silvered mirror 17a reflects some visible light but also passes some visible light, such as is used for a one way mirror.

The partially silvered mirror 17a acts as an important method of aligning the individual's eyes with the field of view of the iris camera(s) while supporting information being presented to the user in real-time. The display behind the mirror can provide information such as focus, eye-openness, remove your glasses, accept/reject or any other feedback deemed pertinent during the transaction all without forcing the user to distract their gaze. The partially silvered mirror allows a “superimposed information” effect much like a heads up display. This combines a natural user interface (looking at oneself in the mirror) with a more information rich user interface without gaze redirection.

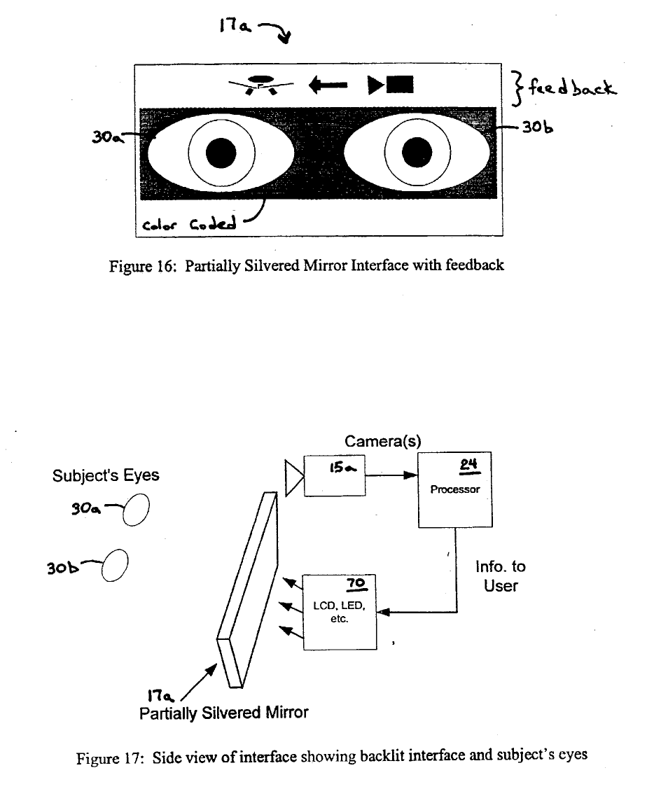

The partially silvered mirror appears like a conventional mirror when installed and the far side behind it is dark. When the far side of the partially silvered mirror has light behind it (e.g., LED(s), LCD), then the user can see through the mirror to a reasonable extent. Yet to a reasonable extent, the user can also see their eyes too. FIG. 16 shows a partially silvered mirror interface with feedback.

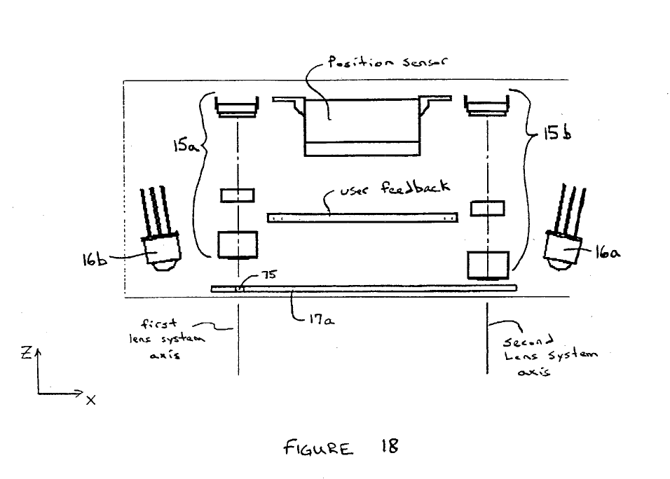

FIG. 17 shows an exemplary layout of a iris capture device 10 including a partially silvered mirror 17a, the subject's eye 30a, 30b, an iris imaging camera 15a, 15b (only one shown), a processor 24, and a display 70 (e.g., a light source). The iris imaging cameras 15a, 15b are positioned on each side of the partially silvered mirror 17a (only one shown). The display 70 is positioned behind the partially silvered mirror 17a. The display 70 communicates (e.g., feeds back) information indicative of the user position to the user. The light source can be as simple as an LED or be as complex as an entire graphic display, such as an LCD. It uses the same basic idea as a heads up display but for use in iris identification.

As shown in FIG. 18, in an embodiment having a partially silvered mirror 17a, the lens systems 15a and 15b can be positioned behind the partially silvered mirror 17a to further improve ease of use. The horizontal (X-axis) dimensions of the partially silvered mirror 17a could be extended beyond the axis of the lens systems (e.g., beyond the average eye separation), placing the lens systems 15a, 15b behind the partially silvered mirror 17a. This improves ease of use because the larger mirror provides better feedback to the user over a greater range of locations. The lens systems 15a, 15b could image an iris of the eye of the user through the partially silvered mirror 17a, or through small apertures 75 (only one shown) in the mirror so that the mirror would not adversely reduce the level of illumination reaching the cameras.

The present invention is also directed to an method for imaging an area of an object positioned behind a light transmissive structure (e.g., eyeglasses) using illuminators which produce specular reflections on the eyeglasses while avoiding specular reflections from falling onto an area of the object to be imaged. An exemplary method includes the steps of: providing a first lens system; providing a second lens system positioned a predetermined distance from the first lens system; providing a first illuminator positioned outboard of the second lens system for operating with the first lens system to capture an image of either a left eye or a right eye; providing a second illuminator positioned outboard of the first lens system for operating with the second lens system to capture an image of either a left eye or a right eye; separating the first illuminator from the first lens system a distance apart from one another to ensure a minimum angular separation so that no reflections due to eyeglasses fall within an iris image area; separating the second illuminator from the second lens system a distance apart from one another to ensure a minimum angular separation so that no reflections due to eyeglasses fall within an iris image area; illuminating the area with the first illuminator and checking to see if the first illuminator has produced a specular reflection that obscures the area of the object; if the first illuminator has produced a specular reflection that obscures the area of the object then illuminating the area with the second illuminator; obtaining an image of the area while the first illuminator is on using the first imager if the first illuminator has produced a specular reflection that has not obscured the area; and obtaining an image of the area while the second illuminator is on using the second imager if the first illuminator has produced a specular reflection that has obscured the area.

The method also includes separating the first illuminator from the first lens and separating the second illuminator from the second lens system a distance sufficient to ensure a minimum angular separation of about 11.3 degrees. In addition, the method includes the step of expanding an apparent capture volume defined by dimensions X, Y, and Z, wherein the expanded capture volume is formed by extending a dimension of the capture volume in one or more of an X-axis, a Y-axis, and a Z-axis.

Although illustrated and described herein with reference to certain specific embodiments, it will be understood by those skilled in the art that the invention is not limited to the embodiments specifically disclosed herein. Those skilled in the art also will appreciate that many other variations of the specific embodiments described herein are intended to be within the scope of the invention as defined by the following claims.

What is claimed is:

1. An iris image capture device having an expanded capture volume comprising:
two lens systems comprising:
a first lens system; and
a second lens system;
wherein said first lens system and said second lens system are offset from one another in one or more of a X-axis, a Y-axis, and a Z-axis and arranged to capture an iris image of at least one of a left eye and a right eye;
two illuminators comprising:
a first illuminator positioned outboard of said second lens system; and
a second illuminator positioned outboard of said first lens system;
wherein said first illuminator and said second illuminator are offset from one another in one or more of a X-axis, a Y-axis, and a Z-axis for illuminating an iris of said at least one of said left eye and said right eye,
wherein said first lens system operates with said first illuminator and said second lens system operates with said second illuminator to illuminate an iris of an eye and capture an image of said iris.

2. The device of claim 1, further comprising an expanded apparent capture volume defined by dimensions X, Y, and Z, wherein said expanded capture volume is formed by extending a dimension of said capture volume in one or more of said X-axis, said Y-axis, and said Z-axis.

3. The device of claim 1, wherein:
said first lens system and said second lens system are horizontally offset from one another in an X-axis a known distance corresponding to an average eye separation;
said first lens system and said first illuminator are horizontally offset from one another in said X-axis and are positioned relative to one another having a known separation; and
said second lens system and said second illuminator are horizontally offset from one another in said X-axis and are positioned relative to one another having a known separation.

4. The device of claim 3, wherein said known distance corresponding to an average eye separation ensures that said first lens system is on-axis with said left eye and said second lens system is on-axis with said right eye when a user is positioned directly in front of said iris image capture device.

5. The device of claim 1, further comprising an expanded apparent capture volume of said iris image capture device formed along an X-axis by extending an apparent width of field along a X-axis by positioning said illuminators outboard of said lens systems and allowing each of said lens systems to capture an iris image of either or both of said left eye and said right eye.

6. The device of claim 1, further comprising:
a maximum apparent width of field that extends in said X-axis, wherein said maximum apparent width of field comprises:
a distance in said X-axis between:
a maximum right position where a left iris inner boundary is located juxtaposition a right FOV outer boundary wherein an image of a left iris can be captured in said right FOV when a user's head is shifted to the right;
a maximum left position where a right iris inner boundary is located juxtaposition a left FOV outer boundary wherein an image of a right iris can be captured in said left FOV when the user's head is shifted to the left.

7. The device of claim 1, further comprising an expanded apparent capture volume of said iris image capture device formed along a Z-axis by extending an apparent depth of field by offsetting said depth of field of each lens system from one another.

8. The device of claim 7, wherein said offset of said depth of field of each lens system is accomplished by physically offsetting each lens system from one another in said Z-axis.

9. The device of claim 7, wherein said offset of said depth of field of each lens system is accomplished by optically offsetting each lens system from one another.

10. The device of claim 9, wherein said optical offset of each lens system is accomplished by using lens systems having different lens prescriptions.

11. The device of claim 1, further comprising a third lens system and a third illuminator that are vertically offset in a Y-axis from said first lens system, said second lens system, said first illuminator, and said second illuminator to form an apparent expanded capture volume along a Y-axis.

12. The device of claim 11, further comprising an expanded apparent capture volume of said iris image capture device formed along said Y-axis by extending an apparent height of field by offsetting said height of field of each lens system from one another.

13. The device of claim 1, further comprising a tilt mechanism for rotating said lens systems up and down.

14. The device of claim 1, further comprising a pan mechanism for rotating said lens systems left and right.

15. The device of claim 1, further comprising an autofocus feature for focusing said lens systems on an iris of an eye of a user.

16. The device of claim 1, further comprising a user interface, wherein said user interface assists a user in positioning him or herself with respect to said iris imaging device in X, Y, Z coordinates.

17. The device of claim 16, wherein said user interface further comprising one or more of a visual indicator and an audio indicator.

18. The device of claim 16, wherein said user interface further comprising a partially silvered mirror for selectively viewing one of a reflection of said eyes reflecting off of said partially silvered mirror and a graphic display positioned behind said partially silvered mirror and projected through said partially silvered mirror.

19. The device of claim 18, wherein,
said lens systems are horizontally offset from one another a distance in said X-axis a distance corresponding to an average eye separation;
a horizontal dimension of said partially silvered mirror is extended beyond an axis of said lens systems; and
said lens systems are positioned behind said partially silvered mirror to further improve ease of use.

20. The device of claim 19, further comprising apertures in said partially silvered mirror along an axis of each of said lens systems for allowing illumination to pass through said partially silvered mirror and enter said lens systems to capture an image of an iris of an eye of said user through said partially silvered mirror.

21. The device of claim 1, further comprising:
a camera processor (ASIC) for controlling the operation of a sensor and optics of each of said first and second lens systems; and
a micro-controller for controlling the operation of said first and second lens systems and an illumination circuitry of each of said first and second illuminators.

22. The device of claim 1, further comprising:
a separation defined by a distance in said X-axis between each lens systems and its corresponding illuminator;
a distance between a front of said lens system and an eye of a user of said iris image capture device; and
a minimum angular separation defined by an angle formed between a line extending along an illumination axis and a line extending along a lens system axis, wherein said minimum angular separation ensures no reflections due to eyeglasses fall within an iris image area.

23. The device of claim 22, wherein said minimum angular separation comprises an angle of about 11.3 degrees.

24. The device of claim 1, further comprising a minimum angular separation defined by a line of sight between said illuminator and an eyeglass lens and a line of sight between said eyeglass lens and a lens of said lens system, wherein said minimum angular separation comprises an angle of about 11.3 degrees.

25. The device of claim 1, wherein said first illuminator is positioned with respect to said first lens system, and said second illuminator is positioned with respect to said second lens system a distance apart from one another which ensures a minimum angular separation of about 11.3 degrees.

26. The device of claim 1, further comprising a Wide Field Of View (WFOV) camera for locating a position of an eye of a user, wherein an output from said WFOV camera is used to control one or more of a tilt mechanism and a pan mechanism.

27. A system for imaging an area of an object positioned behind a light transmissive structure using an illuminator that produce specular reflections on said light transmissive structure comprising:
a single lens system having a sensor for capturing an image of said object behind said light transmissive structure;
a single illuminator positioned having a known separation from said lens system;
an object distance between said lens system and said object to be imaged; and
a minimum angular separation defined an angle formed between an illumination axis and a lens system axis, wherein said minimum angular separation ensures that no specular reflections fall onto an area of an object to be imaged.

28. The system of claim 27, wherein said minimum angular separation comprises an angle of about 11.3 degrees.

29. The system of claim 27, wherein said illumination axis is defined by a line between said illuminator and said light transmissive structure and said lens system axis is defined by a line between said light transmissive structure and said lens system.

30. The system of claim 27, wherein said minimum angular separation is ensured by manipulating said separation between said lens system and said illuminator and said object distance between said lens system and said object to be imaged.

31. The system of claim 27, wherein said separation between said lens system and said illuminator varies between about 1.2 inches and about 5.2 inches and said object distance between said lens system and said object to be imaged varies between about 6 inches and about 26 inches.

32. The system of claim 27, wherein said object to be imaged is positioned directly in front of said lens system.

33. A method for imaging an area of an object positioned behind a light transmissive structure using illuminators which produce specular reflections on said light transmissive structure while avoiding specular reflections from falling onto said area of said object to be imaged, said method comprising:
providing a first lens system;
providing a second lens system positioned a predetermined distance from said first lens system;
providing a first illuminator positioned outboard of said second lens system for operating with said first lens system to capture an image of either a left eye or a right eye;
providing a second illuminator positioned outboard of said first lens system for operating with said second lens system to capture an image of either a left eye or a right eye;
separating said first illuminator from said first lens system a distance apart from one another to ensure a minimum angular separation so that no reflections due to eyeglasses fall within an iris image area;
separating said second illuminator from said second lens system a distance apart from one another to ensure a minimum angular separation so that no reflections due to eyeglasses fall within an iris image area;
illuminating said area with said first illuminator and checking to see if said first illuminator has produced a specular reflection that obscures said area of said object;
if said first illuminator has produced a specular reflection that obscures said area of said object then illuminating said area with said second illuminator;
obtaining an image of said area while said first illuminator is on using said first imager if said first illuminator has produced a specular reflection that has not obscured said area; and
obtaining an image of said area while said second illuminator is on using said second imager if said first illuminator has produced a specular reflection that has obscured said area.

34. The method of claim 33, wherein said step of separating said first illuminator from said first lens and said step of separating said second illuminator from said second lens system further comprise the step of ensuring a minimum angular separation of about 11.3 degrees.

35. The method of claim 33, further comprising the step of expanding an apparent capture volume defined by dimensions X, Y, and Z, wherein said expanded capture volume is formed by extending a dimension of said capture volume in one or more of said X-axis, said Y-axis, and said Z-axis.

36. The method of claim 35, wherein the step of expanding an apparent capture volume further comprises the steps of:
expanding said apparent capture volume along an X-axis by,
extending an apparent width of field along a X-axis by,
positioning said illuminators outboard of said lens systems, and
capturing an iris image of either or both of said left eye and said right eye using either of said lens systems.

37. The method of claim 36, further comprising the steps of:
extending said apparent width of field to a maximum distance in said X-axis by:
positioning a left iris inner boundary juxtaposition a right FOV outer boundary defining a maximum right position
capturing an image of a left iris in said right FOV when a user's head is shifted to the right; and
positioning a right iris inner boundary juxtaposition a left FOV outer boundary defining a maximum left position;
capturing an image of a right iris in said left FOV when the user's head is shifted to the left.

38. The method of claim 35, wherein the step of expanding an apparent capture volume further comprises the steps of:
expanding said apparent capture volume along a Z-axis by,
extending an apparent depth of field by,
offsetting said depth of field of each lens system from one another, and
capturing an iris image of either or both of said left eye and said right eye using either of said lens systems.

39. The method of claim 38, wherein said step of offsetting of said depth of field of each lens system further comprises the step of physically offsetting each lens system from one another in said Z-axis.

40. The method of claim 38, wherein said step of offsetting said depth of field of each lens system further comprises the step of offsetting one or more optical properties of each lens system from one another.

41. The method of claim 39, wherein said step of offsetting said one or more optical properties further comprises the step of offsetting a focal length of each lens system from one another.

42. The method of claim 33, further comprising the steps of:
providing a user interface having a feedback mechanism; and
feeding back information indicative of a user position, wherein said user interface assists a user in positioning him or herself with respect to said iris imaging device in X, Y, Z coordinates.

43. The method of claim 42, wherein said step of feeding back information further comprises the step of selectively displaying viewing one of:
a reflection of said eyes reflecting off of a partially silvered mirror; and
a graphic display projected through said partially silvered mirror.
